(19) United States
(12) Patent Application Publication
(10) Pub. No.: US 2011/0125656 A1
(43) Pub. Date: May 26, 2011

(54) Systems And Methods For Serving Legal Process

(76) Inventor: Michael Kingery, Montrose, CO (US)

(21) Appl. No.: 12/952,137

(22) Filed: Nov. 22, 2010

Related U.S. Application Data
(60) Provisional application No. 61/263,288, filed on Nov. 20, 2009.

(51) Int. Cl. G06Q 50/00

(52) U.S. Cl. 705/311

(57) ABSTRACT

A method for serving legal process includes steps of creating, within a web application, a job describing service of papers to an individual, transmitting the job to a mobile device, displaying, on the mobile device, instructions for completing the job, capturing, using the mobile device, evidence of at least one of the instructions being performed, transmitting the evidence from the mobile device to the web application, and verifying, within the web application, that the job has been completed.

### RELATED APPLICATIONS

The present application claims priority to U.S. Provisional Application No. 61/263,288, filed Nov. 20, 2009, the entire content of which is incorporated herein by reference.

### BACKGROUND

One conventional mobile process service system is known. This conventional system requires a specialized laptop computer that can communicate through cellular telephone carriers to web portals. The laptop system allows notes and photographs to be attached to a process service file in the field, and can map addresses for delivery.

The conventional system has many drawbacks, however. For example, the system is built on a Windows platform, and is thus incompatible with most mobile applications that do not use the same operating system. The system is also bulky to transport and expensive (presently around $1600.00). The system also requires additional hardware and software to incorporate additional features, such as a separate camera, recording equipment, and/or a GPS device. The addition of these additional features renders the system even more cumbersome. The system is a one-size-fits-all type that does not take into account unique service considerations that may arise for different geographical jurisdictions, and has no capability to prevent individual process servers from falsifying records. Incorporation of additional hardware and software may also require customization for each respective laptop device.

To use the conventional system, process servers have a specialized laptop computer within an automobile, similar to what is found in many police cars. Although the laptop computer is somewhat portable, for serving process, it can typically only be used for communication purposes or typing notes. The computer hardware does not include an integrated GPS receiver. The computer software does not reference applicable rules of civil procedure for each particular service, nor can it track the progress of an individual process server, such as by reporting the server's location and attempts to serve. The computer is also too cumbersome to accompany a process server when on foot, and cannot later demonstrate evidence of actual service. The conventional system thus does not protect against gutter serves.

### SUMMARY OF THE INVENTION

In an embodiment, a method for serving legal process includes steps of creating, within a web application, a job describing service of papers to an individual, transmitting the job to a mobile device, displaying, on the mobile device, instructions for completing the job, capturing, using the mobile device, evidence of at least one of the instructions being performed, transmitting the evidence from the mobile device to the web application, and verifying, within the web application, that the job has been completed.

In an embodiment, a system for serving process and collecting evidence of proof of service includes a web application for receiving job information provided by a first user, a database for storing the received job information, and a mobile device configured to interact with the web application to transmit the job information to a second user with instructions to the second user for how to perform the job and to record evidence that the job is performed.

In an embodiment, a method of serving legal process, includes steps of creating a job comprising legal documents to be served on a person, transmitting details of the job to a handheld communications device, displaying on the handheld communications device at least some of the details of the job, serving the legal documents on the person according to the at least some of details displayed on the handheld communications device, verifying, through the handheld communications device, that the job has been completed.

### BRIEF DESCRIPTION OF THE FIGURES

FIG. 1 shows one exemplary system for serving legal process, in an embodiment.

FIG. 2 is a flowchart illustrating an exemplary method for serving legal process, in an embodiment.

### DETAILED DESCRIPTION OF THE DRAWINGS

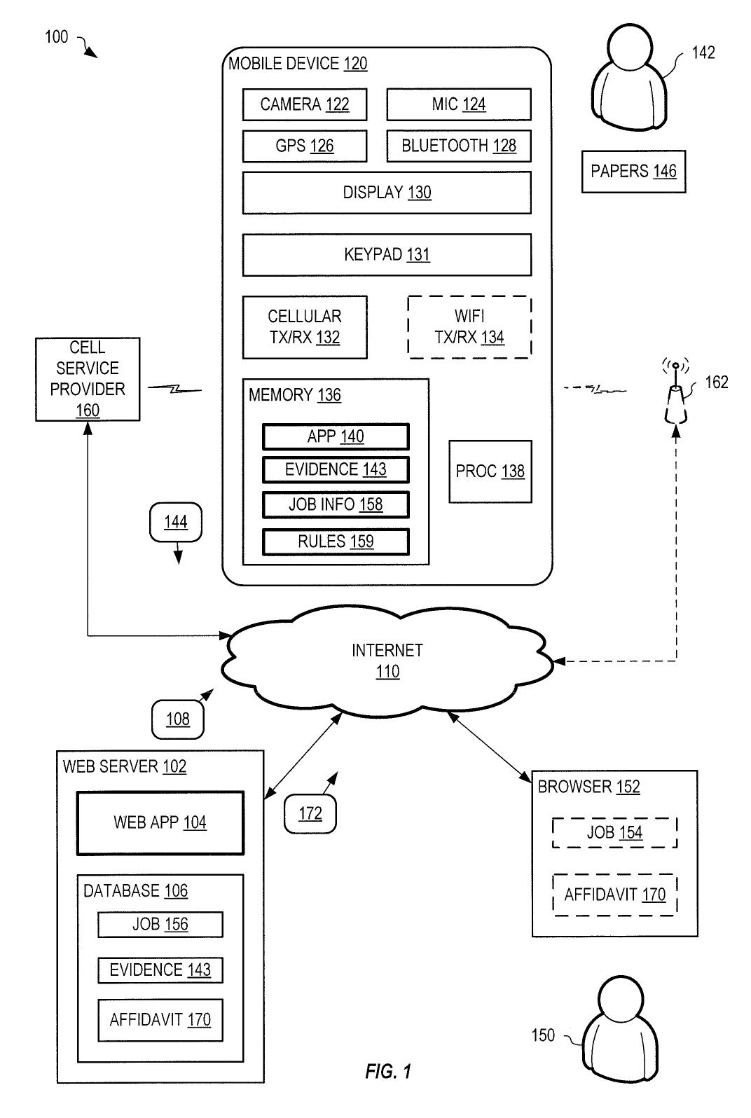

FIG. 1 shows an exemplary system 100 for serving legal process. For example, an attorney 150 who wishes to serve legal papers 146 on an individual (not shown) may hire a process server 142 to deliver the legal papers. Process server 142 receives papers 146 and information and/or instructions regarding the individual for which service is desired. Process server 142 will then follow a strict procedure to ensure that process is correctly served according to at least the location of the individual being served. Attorney 150 can also be a process service company, a law enforcement office or officer, or an employee of a court having jurisdiction over the particular matter for which process is desired.

System 100 includes a web server 102 that has a database 104 and a web application 104 that provides an interface to the database via Internet 110. Web server 102 also communicates with a mobile device 120 via Internet 110. According to an embodiment mobile device 120 may include a camera 122, a microphone 124, a GPS receiver 126, a Bluetooth interface 128, a display 130, a keypad 131, a cellular interface 132, a WiFi interface 134, a memory 136, and/or a processor 138. Mobile device 120 is, for example, a mobile phone such as an Apple iPhone™, a RIM Blackberry™ device, or another handheld device that can incorporate similar features. Display 130 may be a standard screen imaging device, or a touch display having keypad 131 implemented on the display itself. Process server 142 may work for a service company that operates web server 102 and web application 104, for example.

Attorney 150 may utilize a browser 152 to interact with web application 104 running on web server 102 via Internet 110. For example, Attorney 150 interacts with web pages presented by web application 104 via web server 102 to send browser job information 154 to database 106 to be stored as server job information 156. Server job information 156 includes at least browser job information 154. In an example of operation, attorney 150 may include with browser job information 154 a deadline for completing service, a description of papers that are to be served, a name and an address for the individual to be served, and information regarding alternate persons who may be served in place of the individual. Web application 104 sends at least part of server job information 156 to mobile device 120 as package information 108, and a mobile application 140, operating within mobile device 120, stores package information 108 within memory 136 as mobile job information 158. Web application 104 may include additional information from database 106 within package information 108, such as applicable local court rules or rules of civil procedure pertinent to service of papers 146 at the locations where the service is intended. The local court rules may be based upon state and/or county court jurisdictions, and the rules of civil procedure may include federal or state statutory and regulatory requirements.

Mobile application 140 is executed within mobile device 120 by processor 138 and operates to interact with process server 142, using display 130 and keypad 131, and web application 104 via Internet 110. Application 140 operates to display instructions to process server 142 for service papers 146 and for recording evidence 143 of that service. Application 140 sends evidence 143, as message 144, to web application 104 via Internet 110, and web application 104 stores evidence 143 within database 106. In one embodiment, mobile application 140 provides directions to process server 142 for finding the location for service of papers 146. Where process server 142 encounters problems in service of papers 146, mobile application 140 may provide additional relevant information to process server 142, such as an alternate address for the individual, and then provide directions for finding that address.

Web application 104 may also record evidence 143, transmitted from the mobile device 120, of papers 146 having been correctly served by process server 142. The evidence 143 is transmitted to the server 102 by mobile application 140 via Internet 110. Under control of application 140, mobile device 120 may include in the recorded evidence 143 a variety of information from several sources, including but not limited to audio recordings obtained by microphone 124, still images or video recordings obtained by camera 122 (which can include sound obtained by microphone 124), and location snapshots obtained through use of GPS receiver 126. In an example of operation, when ready to serve papers 146, process server 142 may initiate (e.g., by pressing a button on keypad 131) application 140 into a recording mode that can capture and store, as evidence 143, audio, video, and location information. While in this recording mode, process server 142 may then serve papers 146 on the desired individual (or another eligible person who may be indicated by application 140). Mobile device 120 can thus be configured to record into evidence 143 audio, video, and location information obtained during an actual interaction between process server 142 and the individual to be served. Process server 142 may then terminate the recording mode after service has been completed.

Accordingly, by being able to inform process server 142 of pertinent details regarding a particular service, and while also being capable of recording evidence of the service event itself, mobile application 140 miming on mobile device 120 thus provides an easily portable, but inconspicuous, solution that can have continuous connectivity and support from web application 104 via cell service provider 160 and/or via a WiFi hotspot 162.

In an embodiment, mobile application 140 may further utilize Rules of Civil Procedure 159 that can be loaded into memory 136 of mobile device 120 in advance as a complete directory, or with package information 108, which then need only include those rules relevant to the particular service assigned to process server 142. Because individual jurisdictions and/or localities may have different rules and requirements for service, application 140 is able to notify process server 142 of the exact rules applicable to the location of the server. Mobile application 140 may further utilize a known address mapping application with GPS receiver 126 to automatically determine which portions of the Rules of Civil Procedure 159 that process server 142 is to follow. Mobile application 140 may further provide step-by-step instructions to process server 142 how to implement specific rule portions based upon the GPS location of process server 142. In an embodiment, application 140 may further require process server 142 to acknowledge and verify that each instructed step has been correctly followed, and such verification may also be recorded and included within evidence 143.

Mobile application 140 running on mobile device 120 may also provide both training and flexibility for different types of scenarios that process server 142 may encounter during service. In an example of operation, process server 142 arrives at an address of the individual to be served, as directed by mobile application 140, but discovers that the individual has moved from the address. Process server 142 interacts with application 140 to enter this new information, whereupon mobile application 140, if the property is rented, directs process server 142 to ask a current tenant, if present, for contact information of the managing company or landlord. Such received contact information may be entered into mobile application 140 of mobile device 102, from where it may then be sent to web application 104. For example, the managing company or landlord may have a forwarding address for the individual, such as may be entered on a rental application or left for forwarding mail. If the property is owned, mobile application 140 may instead direct process server 142 to search for sales records filed with a county recorder of deeds, for example. Application 140 may be further configured to provide additional training and tips of process serving specifically based upon the experiences of process server 142.

Where process server 142 may be less experienced, mobile application 140 may be configured, through web application 104 for example, to provide more detailed steps to serve papers 146. Alternatively, where process server 142 may have sufficient experience to handle different likely scenarios when serving papers 146, mobile application 140 may be configured, by web application 104 for example, to provide more basic, or less detailed, steps. Accordingly, the amount of training required for a particular process server 142 may be reduced before the particular process server 142 is deemed capable of successfully serving papers 146.

Application 140 may provide at least three levels of security against gutter serves. First, mobile application 140 may provide a physical description of an individual to be served with a plurality of descriptors (e.g., height, hair/eye color, build, noticeable scars/tattoos, ethnicity, other distinguishing features, etc.), of which process server 142 may be asked to verify one or more before service is completed. Second, mobile application 140 may capture audio and/or video recordings, within mobile device 120, while papers 146 are actually being served by process server 142. These recordings may be included within evidence 143 to later prove that the correct individual was identified and served. Third, mobile application 140 may utilize GPS receiver 126 to determine the location, such as a physical address or a latitude and longitude, for example, of process server 142 at the time when service is initiated. This location, with timestamp information, may also be stored within evidence 143.

Additionally, by utilizing the location capabilities of mobile device 120, mobile application 140 may also monitor the location of process server 142 and periodically report the position to web application 104 via Internet 110. Thus, management of the service company or attorney 150 can be aware of the location of process server 142 without the need to continually interrupt the server by calling. This locational ability allows a dispatcher to have an accurate and real-time understanding of resource allocation, that is, the location and availability of individual process servers, and thus mitigate risk and inefficiency experienced by accepting “rush jobs.” Rush jobs are jobs that, if accepted, would need to be performed immediately. The ability to monitor the location of process server 142 allows management to maintain and maximize productivity. For example, it may be more expedient to allocate a rush job to a process server 142 in the location requiring service, even if the process server is working on another matter, rather than allocate the matter to a process server that is free, but a significant distance from the location requiring service.

By utilizing GPS receiver 126 of mobile device 120, the present system is advantageous over the conventional system because an external GPS receiver is not required for recording and/or reporting location information of the service. Furthermore, GPS receiver 126 allows mobile application 140 to provide, to process server 142, turn-by-turn directions, on foot or in an automobile, to reach the service location, thereby allowing process server 142 to take the most optimal route to the service location and to optimize the order of services to maximize productivity. The conventional system is incapable of providing such directions to a process server 142 on foot, or safely on a laptop computer to the server while the server is driving an automobile to reach the service location.

In an embodiment, application 140 sends information regarding a service to web application 104 in real-time. That is, as process server 142 enters information to mobile application 140, or mobile application 140 determines a location of process server 142 using GPS receiver 126, mobile application 140 sends the information to web application 104 via Internet 110. Thus, web application 104 may monitor the progress of process server 142 while serving papers 146 on a particular individual. For example, web application 104 may determine how many service attempts have been made by process server 142, and how many services have been completed successfully. Web application 104 may reprioritize other jobs that may be allocated to process server 142, if necessary, based upon progress (or lack thereof) of process server 142 during a particular service job.

Web application 104 may additionally help to mitigate the safety of process servers by tracking their GPS locations, recorded audio/video conversations during service, and the progress of an individual job according to verified steps, according to the systems and methods discussed above. Process servers are known to encounter danger while attempting to serve papers, and the web application 104 may include automatically-timed triggers if too much time has passed between verification steps or allocated jobs. The trigger may alert attorney 150 (or a service company employer) to contact process server 142, by telephoning, texting, or emailing directly to mobile device 120, or application 140 may alert process server 142 to verify on the mobile device 120 their safety. If contact with process server 142 is lost, audio, video, and/or locational information recorded by mobile device 120 may assist to direct emergency services to the location of process server 142.

Reporting on Each Attempt Made

Mobile application 140 is capable of reporting each service attempt to web application 104, and the web application may then generate a report of the service activity. For example, where process server 142 is hired by attorney 150, web application 104 may display a progress report to attorney 150 via web server 102 and web browser 152. Web application 104 may also record, within database 106, information reported and/or evidence recorded by application 140. The service activity reports can be made periodically, at the completion of particular steps for service, and/or in real-time.

Live Skip Tracing Request

Skip tracing, as known in the art, is a colloquial term describing a process of locating an individual's whereabouts for any number of purposes. Because many individuals involved in court proceedings do not want to be located, it is often necessary to “trace” information left behind by the individual who may have “skipped” town to avoid being found. Locating such individuals can be a costly expense for process serving companies or attorneys who often must hire a private investigator to perform the skip tracing. Many process serving companies or attorneys will perform skip tracing in every attempt to serve process on an individual.

By performing the steps provided by mobile application 140 though, process server 142 may be able to locate a particular individual without requiring a skip tracing. After particular steps from the application 140 are displayed to the process server 142, verified by process server 142 as having been completed, but the individual still cannot be located, the application 140 can then automatically indicate the need to perform a skip trace for the individual. The indication can be displayed to the process server 142 on the display 130, or can be in the form of an automatic request sent by the application 140 to the web server 102. According to this embodiment, skip tracing need not be performed in every instance, and instead only when necessary, thereby reducing expenses experienced in performing unnecessary skip traces.

Additional Information Gathered

As described above, mobile application 140 has additional advantages over the conventional system in that application 140 may gather information and evidence in real time. The types of information gathered regarding the service include, but are not limited to: time, date, identity of the process server, location (GPS), audio recordings, and image recordings (still and/or video). This information can be stored as evidence 143 in either or both of memory 136 of mobile device 120 and database 102 of web server 102, and this information/evidence may then have attached to it additional verification information from objective third parties, such as the cellular service provider, web server 102, or a program such as Google Maps, etc.

By including such verification information with stored evidence 143, proof of service does not have to be completely reliant upon only information entered by process server 142. Specifically, the recorded information can be derived from and verified by objective data (time stamps, GPS locations, etc.) from reliable sources, thereby avoiding problems that can arise from human error or human misinformation. The conventional system described above relies only on input from a human process server to verify that process was served correctly. According to the present system and methods though, input from process server 142 can be objectively verified, and even in real time, thereby allowing for errors to be corrected in a timely manner.

Photo and Video Functions

As described above, mobile application 140 further allows process server 142 to capture evidence, by using mobile device 120, in the form of recorded photos, video, and audio, of the individuals being served, potential witnesses to the service, the event of the service itself, and even of potential property assets of the individuals being served. Such information may often be used as evidence in later court proceedings, or may be helpful when attempting to later locate the same individuals or their assets.

Alarms

Web application 104 is further capable of integrating deadlines, due dates, and court rules for each individual service, and web application 104 still further set pertinent alarms and/or timers for each of such specific deadlines or rules alert process server 142 on display 130 and/or attorney 150 on browser 152. For example, five days prior to a service due date, attorney 150 or process server 142 may be alerted to allocate resources to perform a process service. Additionally, an alert may be sent from web application 104 to attorney 150 that an affidavit must also be filed with a particular court within 10 days after the service of process has been completed by process server 142. Web application 104 may include additional alarms to instruct attorney 150 to later verify that the court has acknowledged in its records the affidavit.

Scanning Function

Mobile device 120 may also include a capability to photograph and/or scan documents into evidence 143, convert the documents into a desired format (PDF, for example), and then directly email and/or upload the document from evidence 143 to web application 104 for additional electronic storage or filing. According to this embodiment, process server 142 need not make as many physical copies of documents encountered or created during the service of process, nor is process server 142 required to carry or locate a separate computer and scanner to perform similar functions, as would be required by the conventional system.

Special Instructions

Similar to the training features, described above, web application 104 and application 120 may allow attorney 150 to send special instructions to process server 142 concerning specific scenarios or individuals related to service of papers 146. These special instructions may include, but are not limited to, geographical considerations, warnings about the individual being served, and weather conditions. According to this embodiment, web application 104 can still transmit standard detailed instructions to process server 142 to perform an effective service, yet still further customize those instructions to the particular job being performed.

Affidavit Preparation

In an embodiment, web application 104 may also automatically prepare affidavits or other necessary documents based upon information collected by application 140 during service of papers 146. This automatic preparation thereby improves efficiency and reduces the possibility of human error. The conventional system, on the other hand, requires manual entry of information onto a paper form (i.e., an affidavit) by a process server, or another individual working with the process server. In an embodiment, system 100 automatically generates an affidavit 170 according to the particular requirements of the court in which affidavit 170 is to be filed, and based upon evidence 143 collected by application 140 running on mobile device 120. In the example shown in FIG. 1, affidavit 170 is initially sent as message 172 to attorney 150, who can then print the affidavit 170 in physical for filing with the court. This automatic preparation can eliminate considerable time and expense seen by process serving companies, and also reduce the risk of papers getting lost when having to be transferred, often through several hands, between process server 142 and attorney 150.

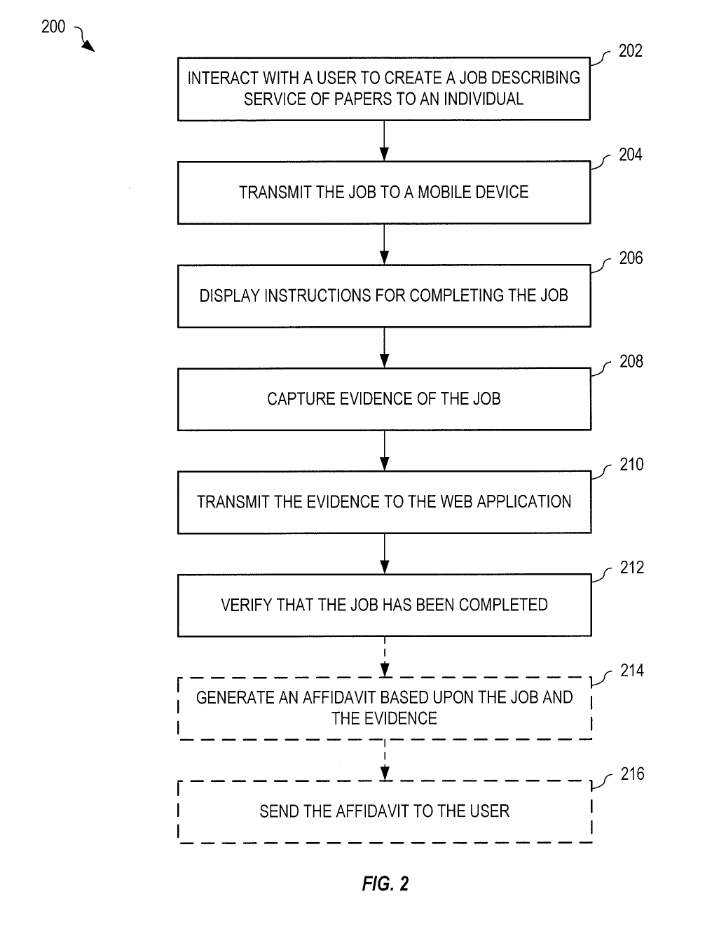

FIG. 2 is a flowchart illustrating a method 200 for serving legal process. Steps 202, 204, 212, and 214 of method 200 may be implemented within web application 104 of web server 102 (see FIG. 1), and steps 206 through 210 of method 200 may be implemented within application 140 of mobile device 120.

In step 202, web application 104 may interacts with a user (e.g., attorney 150) to create a job describing service of process on an individual. In an example of step 202, web application 104 interacts with attorney 150 to create job 156, stored within database 106. In step 204, web application 104 transmits the job 156 to a mobile device. In an example of step 204, web application 104 transmits, via Internet 110, message 108 containing information of job 156 to application 140 running on mobile device 120, where job 156 is stored within memory 136 as job information 158.

In step 206, mobile application 140 displays instructions for completing the job 156. In an example of step 206, application 140 displays instructions and job information 158 for job 156 to process server 142 on display 130 of mobile device 120. In step 208, mobile application 140 captures evidence of at least one of the instructions being completed. In an example of step 208, process server 142 uses microphone 124 of mobile device 120 to capture audio recordings of an individual as papers 146 are being served on the individual. Process server 142 may also use camera 122 to capture image/video recordings of the individual being served. Both of the audio and image/video recordings so captured are stored within evidence 143 of memory 136.

In step 210, mobile application 140 transmits the evidence from the mobile device to the web application. In an example of step 210, application 140 transmits, via Internet 110, evidence 143, as message 144, to web application 104. In step 212, mobile application 140 verifies that job 156 has been completed. In an example of step 212, mobile application 140 transmits evidence 143, as message 144, to web application 104, which then stores message 144 as evidence 143 in database 106.

In step 214, web application 104 may optionally generate an affidavit based upon evidence 143 in database 106. In an example of step 214, web application 104 may automatically generate affidavit 170 based upon information from both job 156 and evidence 143. In step 216, web application 104 may optionally transmit affidavit 170 to a particular user. In an example of step 216, web application 104 transmits affidavit 170, as message 172, to attorney 150 via internet 170, such that attorney 150 may electronically file and/or print affidavit 170 using browser 152.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for serving legal process, comprising the steps of:
creating, within a web application, a job describing service of papers to an individual;
transmitting the job to a mobile device;
displaying, on the mobile device, instructions for completing the job;
capturing, using the mobile device, evidence of at least one of the instructions being performed;
transmitting the evidence from the mobile device to the web application; and
verifying, within the web application, that the job has been completed.

2. The method of claim 1, the evidence comprising a location of the mobile device determined during the step of capturing.

3. The method of claim 1, the evidence comprising an audio file recorded during the step of capturing.

4. The method of claim 1, the evidence comprising at least one digital image recorded during the step of capturing.

5. The method of claim 1, the step of displaying further comprising a step of providing training instructions.

6. The method of claim 1, further comprising, after the step of transmitting and before the step of verifying, a step of initiating a request for a live skip tracing.

7. The method of claim 1, further comprising, prior to the step of verifying, a step of reporting to the web application each unsuccessful attempt to complete the job.

8. The method of claim 1, further comprising, after the step of verifying, a step of automatically generating an electronic affidavit based upon the evidence and the job.

9. A system for serving process and collecting evidence of proof of service, comprising:
a web application for receiving job information provided by a first user;
a database for storing the received job information; and
a mobile device configured to interact with the web application to transmit the job information to a second user with instructions to the second user for how to perform the job and to record evidence that the job is performed.

10. The system of claim 9, wherein the mobile device sends the evidence to the web server as collected, the web server automatically generating at least one affidavit based at least in part upon the evidence.

11. A method of serving legal process, comprising the steps of:
creating a job comprising legal documents to be served on a person;
transmitting details of the job to a handheld communications device;
displaying on the handheld communications device at least some of the details of the job;
serving the legal documents on the person according to the at least some of details displayed on the handheld communications device;
verifying, through the handheld communications device, that the job has been completed.
